(19) United States
(12) Patent Application Publication
(10) Pub. No.: US 2025/0104883 A1
(43) Pub. Date: Mar. 27, 2025

(54) APPARATUS FOR LASER-DRIVEN INERTIAL CONFINEMENT AND TRITIUM PRODUCTION

(71) Applicant: Massachusetts Institute of Technology, Cambridge, MA (US)

(72) Inventors: Keith A. NELSON, Newton, MA (US); Steven E. KOOI, Lexington, MA (US); Yun KAI, Cambridge, MA (US)

(73) Assignee: Massachusetts Institute of Technology, Cambridge, MA (US)

(21) Appl. No.: 18/917,271

(22) Filed: Oct. 16, 2024

Related U.S. Application Data
(63) Continuation-in-part of application No. 17/066,909, filed on Oct. 9, 2020, now Pat. No. 12,148,536.
(60) Provisional application No. 62/913,940, filed on Oct. 11, 2019.
(60) Provisional application No. 63/701,048, filed on Sep. 30, 2024.

(51) Int. Cl. G21G 1/12; G21B 1/03; G21B 1/13; G21B 1/19; G21B 1/23; G21G 1/00

(52) U.S. Cl. CPC G21G 1/12; G21B 1/03; G21B 1/13; G21B 1/19; G21B 1/23; G21G 1/001; G21G 2001/0094

(57) ABSTRACT

An apparatus and method produce, from a Gaussian laser pulse, a sequence of laser rings having a spatiotemporal configuration such that impingement of the laser rings on a surface of a nuclear material in a target assembly produces constructively interfering shock waves that converge on a focal region of the nuclear material, thereby producing sufficient pressures and temperatures to form tritium in the focal region. The temporal and/or spatial intervals between the concentric pulsed laser rings are adjusted to substantially match propagation times of impingement from one ring to the next in a shock propagation layer of the target assembly. A second laser or neutron tube may be used to create a cavitation bubble at the focus. In addition to the shock waves generated in the plane of the surface, through-plane shock waves can be generated to increase the overall shock pressure.

### CROSS REFERENCE TO RELATED APPLICATIONS

This application is a continuation-in-part of U.S. application Ser. No. 17/066,909, filed Oct. 9, 2020, which claims the benefit of U.S. Provisional Application 62/913,940, filed Oct. 11, 2019. This application also claims the benefit of U.S. Provisional Application 63/701,048, filed Sep. 30, 2024. The entire contents of the above-identified applications are included herein by reference.

### FIELD

The disclosure pertains generally to the production of tritium, and more particularly to apparatus for producing tritium by pressure waves.

### BACKGROUND

Tritium, an isotope of hydrogen, is of critical importance for nuclear fusion reactions. While deuterium, another hydrogen isotope, is abundantly available in Earth's oceans, tritium is notably scarce in nature due to its relatively short half-life of approximately 12 years. As a result, natural tritium reserves are minimal.

The current method for tritium production relies heavily on a specific type of nuclear fission reactor, namely the Canadian Deuterium Uranium (CANDU) reactor, which employs heavy water as a moderator. However, the limited number of CANDU reactors worldwide has led to a constrained supply of tritium, thereby creating a bottleneck in the fusion energy supply chain. At present, the global tritium stockpile is estimated to be approximately 28 kilograms. This stockpile is projected to experience a significant depletion post-2030 due to the anticipated decommissioning of CANDU reactors.

The demand for tritium is further accelerated by the rapid growth of fusion technology companies, nearly all of which require tritium for their experimental reactors. This increasing demand exacerbates the issue of tritium scarcity, placing the fusion industry at risk of a critical supply shortage.

### SUMMARY

Described herein are systems and techniques to use laser light to efficiently excite a shock wave in a target assembly that includes a fusion sample, allowing it to reach the pressure and temperature conditions required for thermonuclear fusion. A high-energy laser pulse is split into multiple beams, spatially shaped into a set of concentric rings of different diameters, with the time intervals between pulses in different rings and the spatial separations between different rings (i.e. the ring diameters) controlled to match, or substantially match, the propagation trajectory of the laser-driven shock wave from one ring to the next in the sample. This is done in order to fulfill the velocity (or phase) matching conditions for coherent excitation and build-up of a primary shock wave travelling toward the center of the rings where focusing takes place.

Disclosed embodiments allow efficient laser excitation of a velocity-matched shock to obtain a primary shock wave that focuses in the plane of a shock propagation layer. The resulting 2D shock focusing may yield the extreme pressures and temperatures required for thermonuclear fusion. In contrast to laser-based fusion experiments in which multiple laser beams are focused on the opaque surface of a target sphere in order to launch a shock wave that focuses in three dimensions (3D) at the center of the sphere, the multi-ring techniques described herein have the advantage that the shock propagation layer in which the shock propagates is optically accessible and can be exposed to further shock excitation with multiple laser beams. In the techniques described herein, most of the incident laser light can be absorbed by the shock propagation layer, thereby contributing effectively to the buildup of the shock wave. In conventional laser fusion, much of the laser light is reflected by a plasma that is generated during the early part of the pulsed irradiation. The multi-shock techniques described herein can circumvent the problems of reduced shock generation efficiency due to strong light-induced reflectivity.

The structures and techniques disclosed herein can be used for generation of high shock pressure for material characterization, synthesis, and other applications in addition to fusion. In such embodiments, for fusion and other applications, it may be desirable to control the spatial and/or temporal separations between laser-generated lines or rings such that timed sequences of two or more shocks, rather than a single shock, are generated with control over their relative timing and amplitudes.

In a particularly advantageous use, disclosed embodiments provide a detailed and concrete design for a benchtop device specifically engineered for the production of tritium. Embodiments capitalize on the spatial and temporal manipulation of multiple laser pulses to create concentric laser rings on condensed matter samples. Each of these laser rings initiates a two-dimensional focusing shock wave, which then coincides and converges with previous shock waves at a central point within the ring (or line on the planar surface of the sample).

This device is intended to offer a parallelizable, efficient, and safe solution for generating tritium in controlled laboratory environments, thereby addressing the critical shortage of this isotope for fusion reactor applications. For example, embodiments of the device may produce an efficiency of 104 GPa/J or more, measured as pressure generated in the sample divided by laser pulse energy.

According to one aspect of the present disclosure, a method to excite a shock wave in a target assembly includes: splitting a pulsed laser beam into a plurality of pulsed laser beams; spatially shaping the plurality of pulsed laser beams into a plurality of concentric pulsed laser rings of different diameters; and adjusting temporal and/or spatial intervals between the concentric pulsed laser rings to substantially match propagation times of a ring-shaped laser-driven shock wave from one ring to the next in a shock propagation layer of the target assembly.

According to another aspect of the present disclosure, a method to excite shock waves in a sample in a target assembly includes: splitting a pulsed laser beam into a plurality of pulsed laser beams; spatially shaping the plurality of pulsed laser beams into parallel pulsed laser lines; and adjusting the temporal and/or spatial intervals between the parallel pulsed laser lines to substantially match propagation times of a line-shaped laser-driven shock wave from one line to the next in a shock propagation layer of the target assembly.

In some embodiments, spatially shaping the plurality of pulsed laser beams into a plurality of concentric pulsed laser rings and/or parallel pulsed laser lines comprises spatially shaping the plurality of pulsed laser beams using one or more optical phase masks. In some embodiments, adjusting the temporal and/or spatial intervals between the concentric pulsed laser rings and/or parallel pulsed laser lines comprises using a free-space angular-chirp-enhanced delay (FACED) device. In some embodiments, the FACED device comprises an axisymmetric FACED cavity. In some embodiments, the spatial intervals between the pulsed concentric laser rings and/or parallel pulsed laser lines are adjusted using one or more deformable mirrors or spatial light modulators. In some embodiments, the spatial and/or temporal intervals between the pulsed concentric laser rings and/or parallel pulsed laser lines are adjusted by inserting elements of specified thickness and refractive index into the beam paths. In some embodiments, the spatial and/or temporal intervals between the pulsed concentric laser rings and/or parallel pulsed laser lines are adjusted to produce two or more converging shock waves whose relative timing and amplitudes are controlled.

In some embodiments, the ring-shaped shock wave and/or line-shaped laser-driven shock wave propagates substantially within a plane of the shock propagation layer and converges toward a focal region of the target assembly where a fusion sample is positioned. In some embodiments, one or both of the methods includes, coincident or near-coincident with the convergence of the substantially in-plane ring-shaped shock wave and/or line-shaped laser-driven shock wave at the focal region, directing one or more substantially through-plane shock waves at the focal region. In some embodiments, the shock propagation layer is disposed between a first substrate and a second substrate. In some embodiments, the shock propagation layer comprises a liquid or a polymer material that absorbs laser light for effective shock generation. In some embodiments, the shock propagation layer includes a constituent whose absorption spectrum shifts under pressure such that its absorption of the laser light is stronger while the shock is present. In some embodiments, the ring-shaped shock wave and/or shaped laser-driven shock wave converges toward a focal region of the target assembly where a fusion sample is positioned. In some embodiments, the fusion sample includes at least one of: a liquid film of deuterium-tritium; a solid film deuterium-tritium; a liquid film of heavy water (D2O) with a trapped deuterium-tritium bubble; or a frozen film of heavy water with a trapped deuterium-tritium bubble. In any of these example, deuterium-tritium can be replaced with deuterium-only constituents.

According to another aspect of the present disclosure, a system includes: a target assembly having a shock propagation layer; one or more laser sources to generate a pulsed laser beam; and an optical device. The optical device includes: a spatio-temporal splitting system to split the pulsed laser beam into a plurality of laser beam shapes, the laser beam shapes comprising a plurality of pulsed laser rings of different diameters or a plurality of pulsed parallel pulsed laser lines; and one or more shaping elements to shape the plurality of pulsed laser beams into the plurality of pulsed laser rings of different diameters or the plurality of pulsed parallel pulsed laser lines. The optical device is configured to adjust temporal and/or spatial intervals between the laser beam shapes to substantially match propagation times of a shaped laser-driven shock wave from one shape to the next in the shock propagation layer.

In some embodiments, the shock propagation layer is disposed between a first substrate and a second substrate. In some embodiments, the shock propagation layer comprises a liquid or a polymer material that absorbs laser light for effective shock generation. In some embodiments, the shock propagation layer includes a constituent whose absorption spectrum shifts under pressure such that its absorption of the laser light is stronger while the shock is present. In some embodiments, the system can include a fusion sample located at a focal region of the target assembly where the shaped shock wave converges toward. In some embodiments, the fusion sample comprising at least one of: a liquid film of deuterium-tritium; a solid film deuterium-tritium; a liquid film of heavy water (D2O) with a trapped deuterium-tritium bubble; or a frozen film of heavy water with a trapped deuterium-tritium bubble. In any of these example, deuterium-tritium can be replaced with deuterium-only constituents.

Another aspect of the disclosure is an apparatus comprising: a picosecond laser for producing a Gaussian laser pulse; a first plurality of beamsplitters for splitting the Gaussian laser pulse into a plurality of laser pulses; a plurality of axicon telescopes, each axicon telescope coupled to a respective laser pulse in the plurality of laser pulses and having an axicon, wherein each axicon telescope receives its respective laser pulse at a time determined by a distance traveled by the respective laser pulse, and each axicon telescope forms its respective laser pulse into a laser ring having a diameter according to a position of its axicon; and a second plurality of beamsplitters for combining the laser rings into an output series of pulses; wherein the beamsplitters and axicon telescopes are arranged so that the output series of pulses produces shock waves in a sample assembly that constructively interfere at a focal region so as to initiate a fusion reaction that produces tritium.

The apparatus may include, for creating a cavitation bubble in the sample assembly at a focal point of the shock waves, a femtosecond laser, or a picosecond laser, or a nanosecond laser, or a neutron generator tube.

The beamsplitters and axicon telescopes may be configured to excite the sample assembly from two opposite sides thereof.

The sample assembly may have a lithium blanket for neutron bombardment.

The sample assembly may include at least one of: a liquid or solid film of deuterated acetone C₃D₆O; a liquid film of deuterium-tritium; a liquid film of deuterium constituents; a solid film deuterium-tritium; a solid film of deuterium constituents; a liquid film of heavy water (D₂O) with a trapped deuterium-tritium bubble; a liquid film of heavy water with a trapped deuterium bubble; a frozen film of heavy water with a trapped deuterium-tritium bubble; or a frozen film of heavy water with a trapped deuterium bubble.

The sample assembly may be tapered with gradually shrinking sample layer thickness towards the center.

The beamsplitters and axicon telescopes may excite the sample assembly by through-plane shock waves.

Another aspect of the disclosure is a method of producing tritium from nuclear material in a sample assembly. The method comprises: producing a Gaussian laser pulse using a first sub-nanosecond laser; converting the Gaussian laser pulse into laser rings of variable diameters, each such laser ring impinging on the nuclear material at a different time to produce a corresponding shock wave in the nuclear material; and generating a cavitation bubble at a focus of the shock waves in the nuclear material, using a second sub-nanosecond laser or a neutron tube; wherein the shock waves constructively interfere at the focus so as to initiate a fusion reaction that produces tritium.

The fusion reaction may also produce neutrons, the method further comprising directing said neutrons into a breeding blanket.

The breeding blanket may comprise lithium.

The nuclear material may comprise at least one of: a liquid or solid film of deuterated acetone C₃D₆O; a liquid film of deuterium-tritium; a liquid film of deuterium constituents; a solid film deuterium-tritium; a solid film of deuterium constituents; a liquid film of heavy water (D₂O) with a trapped deuterium-tritium bubble; a liquid film of heavy water with a trapped deuterium bubble; a frozen film of heavy water with a trapped deuterium-tritium bubble; or a frozen film of heavy water with a trapped deuterium bubble.

Converting the Gaussian laser pulse into laser rings of variable diameters may comprise splitting the Gaussian laser pulse into a plurality of laser pulses using one or more first beamsplitters; directing each of the plurality of laser pulses into a respective axicon telescope where it is formed into a respective laser ring having a respective diameter; and combining the respective laser rings using one or more second beamsplitters.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of a system for fusion ignition, according to some embodiments of the present disclosure.

FIG. 2A is a pictorial diagram of a planar multi-shock geometry that can be used within the system of FIG. 1, according to some embodiments of the present disclosure.

FIG. 2B is a graphical diagram showing an example of shock build-up using the multi-shock geometry of FIG. 2A.

FIG. 3A is a pictorial diagram showing another planar multi-shock geometry that can be used within the system of FIG. 1, according to some embodiments of the present disclosure.

FIG. 3B is a graphical diagram showing an example of shock build-up using the planar multi-shock geometry of FIG. 3A.

FIG. 4A is a side view diagram of a target assembly that can be used within the system of FIG. 1, according to some embodiments of the present disclosure.

FIG. 4B is a side view diagram of another target assembly that can be used within the system of FIG. 1, according to some embodiments of the present disclosure.

FIG. 5 is a perspective view of a target assembly that can be used within the system of FIG. 1, according to some embodiments of the present disclosure.

FIG. 6 is a plot showing experimentally measured shock pressures in a shock propagation layer versus excitation laser pulse energy.

FIGS. 7 and 8 are flow diagrams showing methods for synchronous excitation of multiple shock waves in a target assembly, according to some embodiments of the present disclosure.

FIG. 9 is a schematic representation of an apparatus for inertial confinement fusion and tritium production according to a first embodiment of the concepts, techniques, and structures disclosed herein.

FIG. 10 is a schematic representation of an apparatus for inertial confinement fusion and tritium production according to a second embodiment of the concepts, techniques, and structures disclosed herein.

FIG. 11 is a perspective view of a sample assembly that can be used with the embodiment of FIG. 10.

FIG. 12 is a graphical diagram showing another pathway for tritium production from D-D fusion.

FIG. 13 is a flow diagram showing a process for tritium production, according to various embodiments.

The drawings are not necessarily to scale, or inclusive of all elements of a system, emphasis instead generally being placed upon illustrating the concepts, structures, and techniques sought to be protected herein.

### DETAILED DESCRIPTION

Disclosed herein are systems, structures, and techniques to efficiently excite a strong shock wave in a target assembly, allowing a fusion sample to reach the pressure and temperature conditions required for thermonuclear fusion.

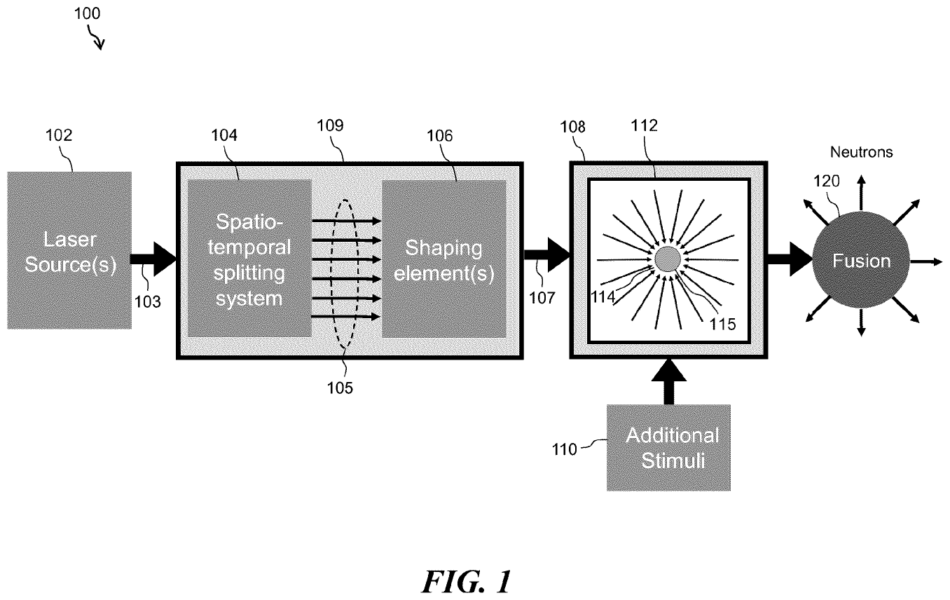

Referring to FIG. 1, according to some embodiments, a system 100 for fusion ignition can include one or more laser sources 102, an optical device for shock velocity-matching 109, and a target assembly 108. The optical device 109 includes a spatio-temporal splitting system 104 and one or more shaping elements 106. The target assembly 108 includes a shock propagation layer 112 and a focal region 114 within the propagation layer 112 where shock is focused on a fusion sample 115. Laser source(s) 102 can generate laser beam(s) or pulse(s) 103 that can be split into multiple beams 105 via spatio-temporal splitting system 104. The laser beam(s) or pulse(s) 103 have an energy level sufficient to create tritium, which may at least 100 millijoules, or at least 1 joule, or at least 10 joules, or at least 100 joules. In some embodiments, laser source(s) 102 can be provided as energy-efficient pulsed lasers, such as Nd:YAG (neodymium-doped yttrium aluminum garnet) lasers. Shaping elements 106, operating in conjunction with spatio-temporal splitting system 104, can shape the multiple beams 105 to cause a velocity-matched shock wave 107 to be optically excited at specifically chosen locations and at controlled delay times. The shock wave 107 can be controlled so as to propagate through the propagation layer 112 and converge (in two-dimensions or three-dimensions) on a fusion sample 115 located within the focal region 114 to produce fusion 120.

The energy released during the fusion process can be collected via the emission of high-energy neutrons and other high-energy particles escaping from the fusion sample 115 at the center of the laser rings. For example, the target assembly 108 can be positioned within a chamber that serves as a heat exchanger, meaning the chamber walls can trap high-energy neutrons and other high-energy particles for conversion of the nuclear energy into heat.

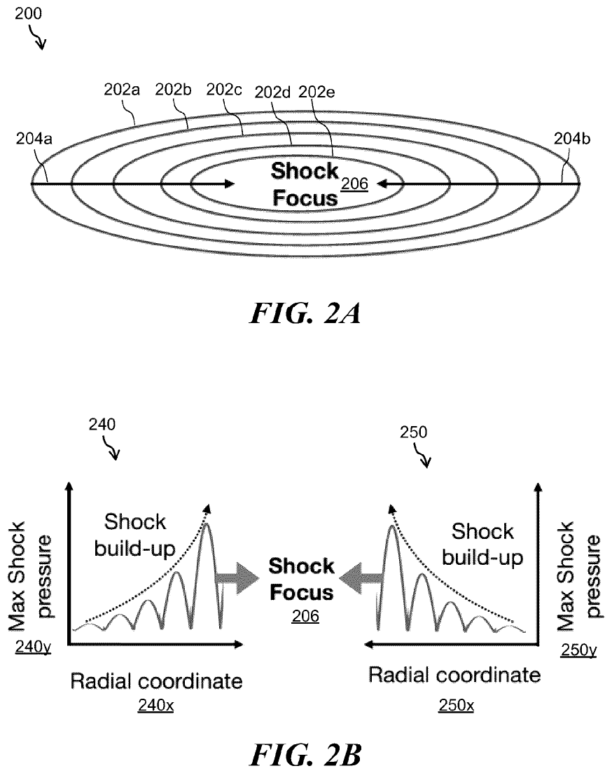

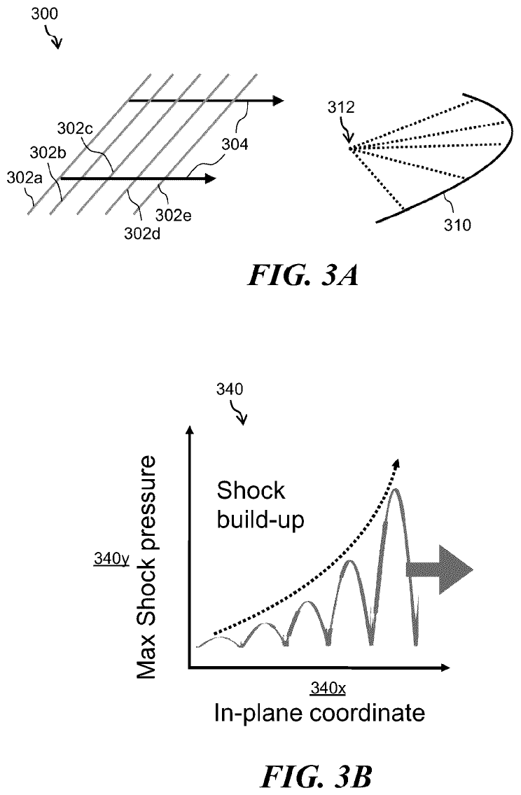

In some embodiments, shaping elements 106 can include an optical phase mask (or multiple masks) to convert an array of beams 105, which might be an array of spatially separated parallel lines, into concentric rings, as described further below in the context of FIG. 2A. In some embodiments, shaping elements 106 can shape the beams 105 into a set of parallel lines, as described below in the context of FIG. 3A, and may include a focusing element placed along the pathway of a line-shaped shock wave to focus the shock energy on the focal region 114.

In some embodiments, shock propagation layer 112 can be provided as a liquid, polymer, or other material type that absorbs a significant fraction of the laser light. In some embodiments, the shock propagation layer includes a constituent whose absorption spectrum shifts under pressure such that its absorption of the laser light is stronger while the shock is present. In some embodiments, the shock propagation layer is disposed between a first substrate and a second substrate. Further discussion of the makeup of a shock propagation layer that can be used within a disclosed fusion ignition system is provided below.

In some embodiments, system 100 can further include additional stimuli 110, such as a through-plane laser-driven shock, laser pulses to optically excite the fusion sample and/or to induce cavitation at or around the fusion sample, or an AC acoustic field acting on a cavitation bubble at the fusion sample, to cause shock waves 107 to be further excited.

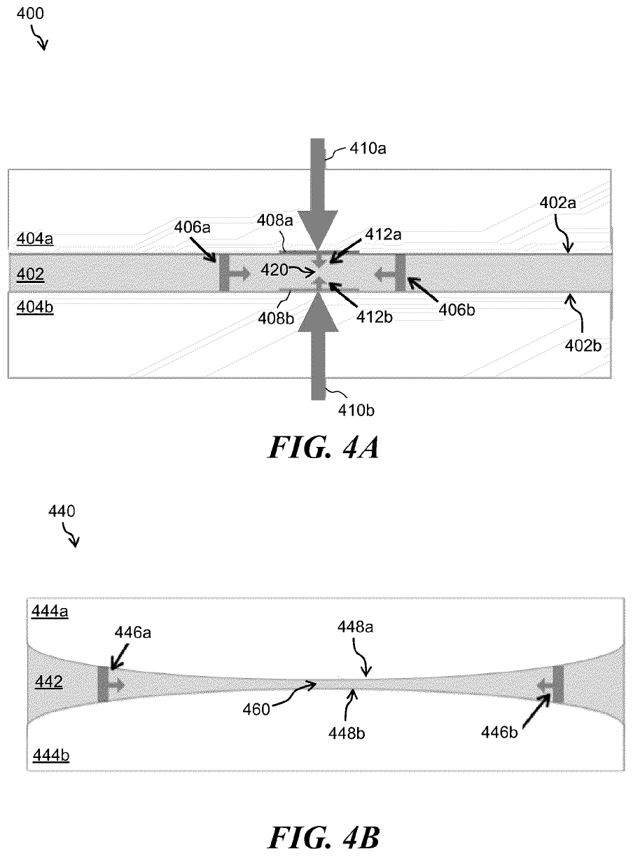

In some embodiments, shock propagation layer 112 can have a thickness of less than 1 mm or less than 0.1 mm. In such embodiments, the primary shock propagation can be within the plane of the shock propagation layer 112 and can converge toward the focal region 114. In some embodiments, fusion sample 115 can be pre-positioned within focal region 114 of target assembly 108. Examples of target assemblies that can be used within system 100 are described below in the context of FIGS. 4A and 4B.

In some embodiments, target assembly 108 can be sealed to reflect the multiple shock waves travelling outward the focal region 114 as well as to confine laser-excited plasma or gases that will further compress, as a piston, the fusion sample 115.

Within system 100, the spatio-temporal control of the laser excitation of phase-matched shock waves can be achieved using a variety of optical designs. For example, system 100 can include the free-space angular-chirp-enhanced delay (FACED) device described in J. -L. Wu et al., Light: Science & Applications 6, 16196 (2017), which publication is hereby incorporated by reference in its entirety. Such an optical device can use multiple reflections between two non-parallel reflectors to produce an optical array of stripes or lines in the focal plane of a lens, with a controllable and well-defined inter-line spacing and with a controllable incremental delay time between successive stripes or lines. A deformable mirror or spatial light modulator (SLM) (or more than one deformable mirror or SLM) can then be used to adjust the spacings between the parallel lines as well as the widths of individual lines. An optical phase mask (or multiple masks) can be designed to transform the stripes into concentric rings of different diameters. In some embodiments, the optical phase mask can be a fixed imprinted pattern on a substrate or a reconfigurable SLM to control each of the individual rings (size, shape and intensity distribution). In some embodiments, the programmable deformable mirrors can be used to control each of the individual rings (size, shape and intensity distribution).

In some embodiments, to provide the spatio-temporal control, system 100 can include a conical cavity made of two conical mirrors or one flat mirror and one conical mirror that can directly output concentric rings of different diameters from a single beam input. This axisymmetric FACED cavity, or conical cavity, made using one or two reflective axicons (conical prisms), can incorporate one or several deformable mirrors. Alternatively, the output from the conical cavity can be directed onto one or more deformable mirrors or SLMs to control the spacings between concentric rings, the widths of the lines that define each ring, and the intensity distribution of light at the rings in the target assembly. In some embodiments, to provide the spatio-temporal control, system 100 can incorporate an optical cavity merging a Herriott multipass cavity and an optical device (e.g., a FACED device) that, in conjunction with an axicon and a focusing lens, produce concentric rings of different diameters in the target assembly 108. The use of a multiple optical ring configuration can extend to far higher shock pressures the method for shock focusing (using a single ring of excitation laser light) demonstrated in the following publications, each of which is hereby incorporated by reference in its entirety.
D. Veysset, S. E. Kooi, R. Haferssas, M. Hassani-Gangaraj, M. Islam, A. Maznev, Y. Chernukha, X. Zhao, K. Nakagawa, D. Martynowich, X. Zhang, A. Lomonosov, C. Schuh, R. Radovitzky, T. Pezeril, Keith A. Nelson, Scr. Mater. 158, 42 (2019).
D. Veysset, U. Gutiérez-Hernandez, L. Dresselhaus-Cooper, F. De Colle, S. Kooi, K. A. Nelson, P. A. Quinto-Su, T. Pezeril, Phys. Rev. E 97, 053112 (2018).
D. Veysset, A. Maznev, István A. Veres, T. Pezeril, S. Kooi, Alexey M. Lomonosov, Keith A. Nelson, Appl. Phys. Lett. 111, 031901 (2017).
D. Veysset, A. Maznev, T. Pezeril, S. Kooi, Keith A. Nelson, Scientific Reports 6, 24 (2016).
D. Veysset, T. Pezeril, S. Kooi, A. Bulou, Keith A. Nelson, Appl. Phys. Lett. 106, 161902 (2015).
T. Pezeril, G. Saini, D. Veysset, S. Kooi, P. Fidkowski, R. Radovitzky, Keith A. Nelson, Phys. Rev. Lett. 106, 214503 (2011).

In contrast to the aforementioned publications, embodiments of the present disclosure can use multiple concentric excitation rings instead of just one excitation ring. Shock focusing at the center of the rings, in conjunction with velocity matching to build up the shock wave as it propagates from one ring to the next, may produce very high pressure and temperature conditions at the center of the rings, that may yield measurable amounts of thermonuclear fusion.

In addition to fusion generation, the system of FIG. 1 can be used for the generation of high shock pressure for material characterization, synthesis, and other applications.

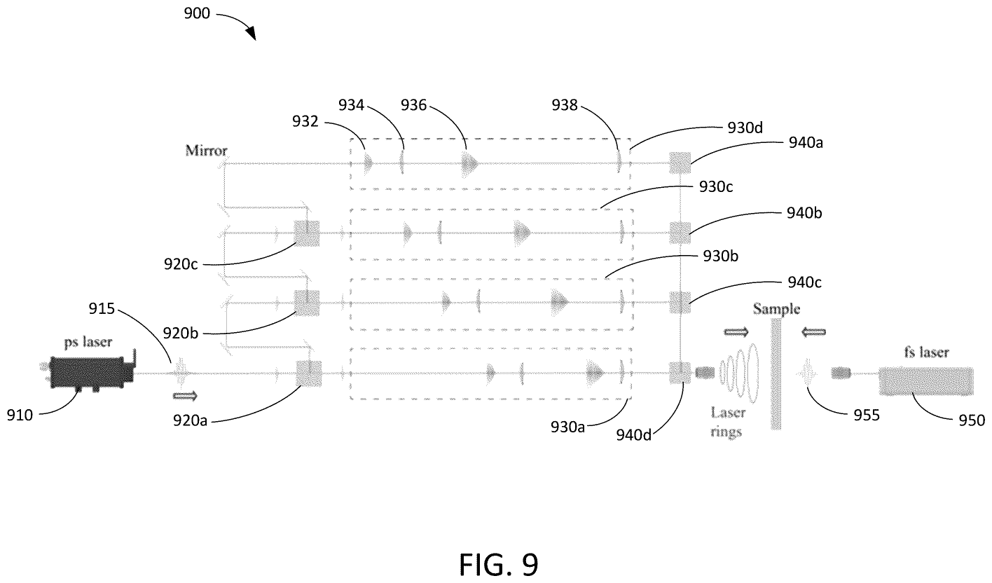

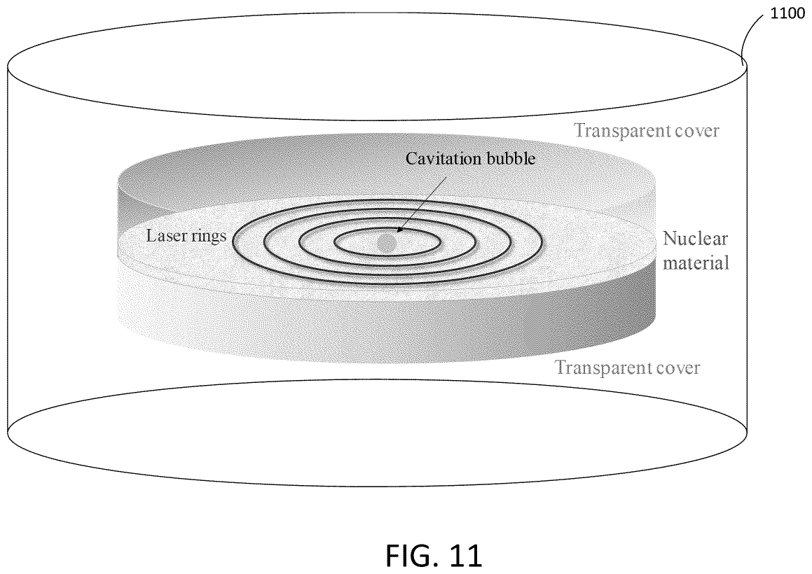

FIG. 2A shows an example of a planar multi-shock geometry 200 that can be used, for example, within the fusion ignition system 100 of FIG. 1. In the illustrated embodiment, multiple laser beams may be spatially shaped (e.g., using elements 104 and 106 of FIG. 1, described in more detail below in connection with FIG. 9 and FIG. 11) into a set of concentric rings 202a-202e (202, generally) of different controllable diameters. Each of these excitation rings 202 can contribute to a shock wave that travels toward a focal region 206 at center of the rings, as illustrated by arrows 204a and 204b. The time intervals between pulses in different rings and/or the spatial separations between different rings 202 can be controlled or adjusted to match the propagation times of the laser-driven shock wave from one ring to the next. That is, the timing of the pulses in the excitation rings and the diameters of the different rings 202 can be controlled to fulfill the velocity matching condition for coherent excitation and build-up of a primary shock wave travelling toward the focal region 206. Shocks other than the “primary” shock may also be launched by the pulsed laser light, and will typically be weaker than the primary shock and may propagate in directions or in regions of the target assembly different from the primary shock.

A fusion sample of interest (e.g., fusion sample 115 of FIG. 1) may be positioned near the center of the rings 206 for fusion ignition. While five (5) concentric rings 202a-202e are shown in the example of FIG. 2A, other numbers of rings (e.g., between 6 and 50 rings) can be used. The sample (sometimes called “target” or “nuclear material” herein) comprises a material conducive to producing tritium via nuclear fusion under high pressures, such as (without limitation) a liquid or solid film of deuterated acetone C₃D₆O; a liquid film of deuterium-tritium; a liquid film of deuterium constituents; a solid film deuterium-tritium; a solid film of deuterium constituents; a liquid film of heavy water (D₂O) with a trapped deuterium-tritium bubble; a liquid film of heavy water with a trapped deuterium bubble; a frozen film of heavy water with a trapped deuterium-tritium bubble; or a frozen film of heavy water with a trapped deuterium bubble.

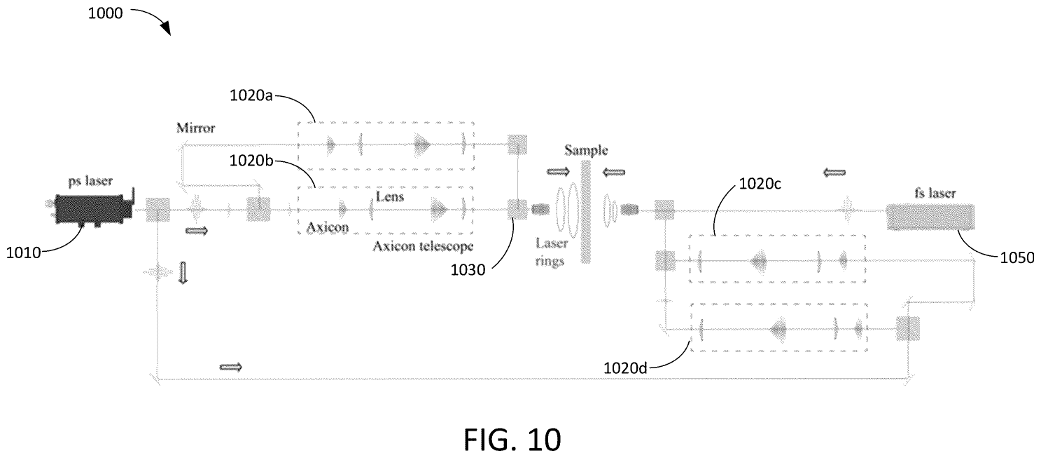

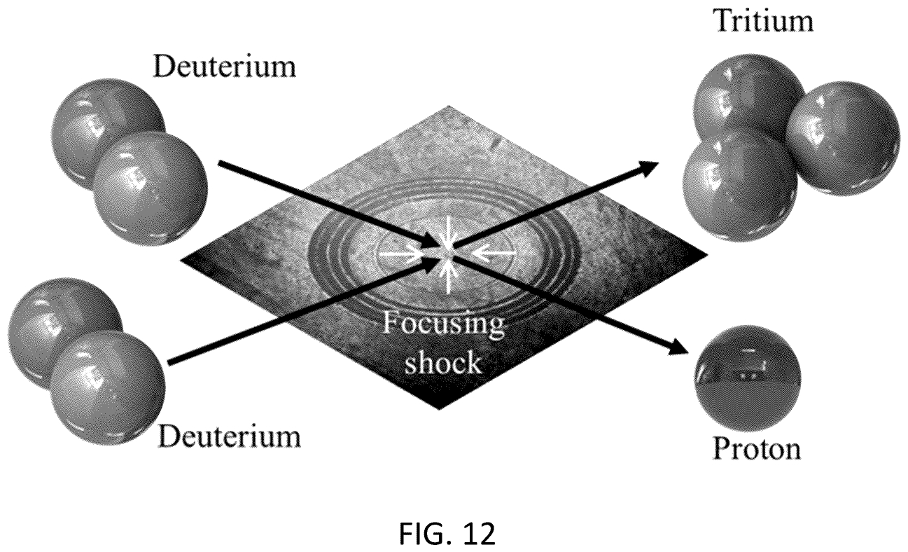

An apparatus (e.g., the apparatus of FIG. 10 or FIG. 12, described below) produces a sequence of laser rings (e.g., the laser rings 202a-e) that impinge upon the sample at different locations and times so as to cause shock waves in the sample that constructively interfere, thereby producing a high pressure at a central shock focus. For purposes of this disclosure, “high pressure” means pressure sufficient to cause nuclear fusion of deuterium into tritium, and may be, e.g., more than 1 GPa, more than 10 GPa, or more than 20 GPa. Notably, the shock waves travel in the sample in a direction perpendicular to the path of the impinging laser beams, typically at a rate of 1-10 microns per second.

FIG. 2B illustrates how velocity-matching allows a build-up of the shock amplitude as the shock wave propagates toward the center of the rings 206 from opposing directions. A first illustrative (qualitative) plot 240 has a horizontal axis 240x representing a first direction of wave propagation (e.g., direction 204a in FIG. 2A) and a vertical axis 240y representing shock pressure. A second illustrative plot 250 has a horizontal axis 250x representing a second direction of wave propagation (e.g., direction 204b in FIG. 2A) and a vertical axis 250y representing shock pressure.

Since shock waves are nonlinear waves whose speeds increase with pressure, the primary shock wave that builds up during propagation toward the center will increase in speed as it gets closer to the center. Therefore, in order to achieve an efficient build-up of the primary shock wave, either the time delay or the spacing between each excitation ring source has to be tuned in order to match the variation of the shock speed toward the center. In general, this means that the spacing or the time delay between successive rings on the sample surface should not be constant. There are several technical possibilities that could be used to fulfill this requirement. For example, in some embodiments, an optical phase mask used to convert an array of lines, with constant inter-line spacing from an optical device (e.g., a FACED device), into concentric rings can be designed such that it would lead to concentric rings with non-constant inter-ring spacings that would match the variation of the shock speed along the sample surface. As another example, an optical device (e.g. a FACED device followed by a deformable mirror or SLM) can be modified to directly output an array of lines with non-constant inter-line spacings that would match the variation of the shock speed. In some embodiments, this can be achieved by replacing one large reflector in the optical device with multiple small reflectors whose positions and reflection angles can be adjusted, or by a large deformable mirror. As another example, optical elements can be inserted inside or outside an optical device (such as FACED cavity) in order to temporally delay the pulses that pass through them, in order to obtain a non-constant time delay between lines or stripes. One or more of these approaches can be used to control the inter-line spacing and timing as required. In other embodiments, a conical FACED cavity could be used as described above to directly generate concentric rings of light, and the spacings between rings could be controlled by a one or more deformable mirrors or SLMs.

While certain embodiments may be described herein with reference to excitation rings, it should be understood that in each case other excitation geometries are possible.

FIG. 3A shows an alternative technique for achieving focusing of the velocity-matched shock that can be utilized, for example, within the fusion ignition system 100 of FIG. 1. In the illustrated planar multi-shock geometry 300, multiple laser beams shaped as parallel lines 302a-302e (302, generally) can arrive at a shock propagation layer with appropriate spatial and temporal intervals to allow velocity matching in order to excite a line-shaped shock wave propagating in the shock propagation layer (e.g., in shock propagation layer 108 of FIG. 1) as illustrated by arrows 304. In some embodiments, a reflective or transmissive acoustic lens 310 can be placed along the pathway of the line-shaped shock wave to focus the shock energy within a focal region 310 on the sample surface. The acoustic lens 310 can be provided as a curved element incorporated into the shock propagation layer.

FIG. 3B shows shock build-up that may occur using the laser beam configuration of FIG. 3A. An illustrative qualitative plot 340 has a horizontal axis 340x representing the direction of wave propagation (e.g., direction 304 in FIG. 3A) and a vertical axis 340y representing shock pressure.

Turning to FIG. 4A, disclosed embodiments allow additional shock excitation, in addition to the multi-shock geometries shown in FIGS. 2A and 3A. An illustrative target assembly 400 can be provided, for example, within the fusion ignition system 100 of FIG. 1. The target assembly 400 includes a shock propagation layer 402 having an upper planar surface 402a and a lower planar surface 402b. An upper substrate layer 404a is disposed over the propagation layer upper surface 402a and a lower substrate layer 404b is disposed below the propagation layer lower surface 402b. In some embodiments, shock propagation layer 402 can be provided as a liquid, polymer, or other material type that absorbs a significant fraction of the laser light. In some embodiments, substrate layers 404a, 404b can be formed from or coated with a hard solid material, such as diamond, boron nitride, sapphire, or other materials that can sustain high pressures and high temperatures and substantially confine the shock wave in the propagation layer.

A fusion sample (not shown) can be pre-positioned in a focal region 420 located, for example, midway along a length of the shock propagation layer 402, as shown. “In-plane” shock waves 406a, 406b can be propagated towards the focal region 420 using, for example, the multi-shock techniques described above in the context of FIGS. 2A and 3A.

Coincident with, or near-coincident with, the arrival of the in-plane shock waves 406a, 406b at the focal region 420, through-plane shock waves 412a, 412b can be generated from above and below the focal region 420 to increase the overall shock pressure. As used herein, the phrase “near-coincident” refers to two events that occur within several nanoseconds of each other (e.g., within less than 10 or less than 100 nanoseconds of each other). In some embodiments, the through-plane shock waves 412a, 412b can be generated by additional stimuli 410a, 410b directed to irradiate absorbing layers or ablators 408a, 408b positioned between the substrate layers 404a, 404b and the shock propagation layer 402 (e.g. fabricated by deposition onto the substrates), as shown. In some embodiments, additional stimuli 410a, 410b may be intense laser pulses up to hundreds of Joules energy (e.g., at least 100 Joules). In some embodiments, additional stimuli 410a, 410b may be light in a frequency range from far-infrared (terahertz frequency range) to x-rays. Thus, using the structures and techniques illustrated in FIG. 4A, a fusion sample can be subjected to both the focusing in-plane shock waves 406a, 406b and the through-plane shock waves 412a, 412b, increasing the total pressure and temperature within focal region 420.

In other embodiments, additional stimuli 410a, 410b from above and below can irradiate the fusion sample itself, or a thin absorbing containment vessel for the fusion sample, rather than absorbing layers 408a, 408b on the substrates 404a, 404b. The fusion sample can be excited this way prior to or approximately coincident with in-plane shock focusing.

Turning to FIG. 4B, in some embodiments, additional shock strength may be achieved using curved or tapered substrates instead of flat parallel substrates. An illustrative target assembly 440 can be provided, for example, within the fusion ignition system 100 of FIG. 1. The target assembly 440 includes a shock propagation layer 442 disposed between an upper substrate 444a and a lower substrate 444b. The substrates 444a, 444b have respective curved surfaces 448a, 448b, shown in FIG. 4B as opposing convex surfaces. A fusion sample (not shown) can be pre-positioned in a focal region 460 located, for example, midway along a length of the shock propagation layer 442, as also shown. In-plane shock waves 446a, 446b can be propagated towards the focal region 460 using, for example, the multi-shock techniques described above in the context of FIGS. 2A and 3A. It should be understood that, with the geometry of FIG. 4B, shock waves 446a, 446b may not be strictly planar but are described herein as “in-plane” or “planar” for convenience. Due to the orientation of the curved substrate surfaces 448a, 448b, the thickness of the shock propagation layer 442 can decrease as the shock focal region 460 is approached. In this way, the propagating in-plane shock waves 446a, 446b can be more and more confined in the through-plane dimension while approaching the shock focal region 460. The shock propagation layer 442 and/or substrate layers 444a, 444b can be provided from any of the materials described above in conjunction with FIG. 4A. Other geometries could also be used to reduce the propagation layer thickness. For example, the two substrates could have two opposing conical surfaces. Alternatively, for example, one flat substrate and one substrate with a convex or conical surface could be used.

In some embodiments, through-plane shock waves can be generated from above and below the focal region to increase the overall shock pressure using structures and techniques similar to those described above for FIG. 4A.

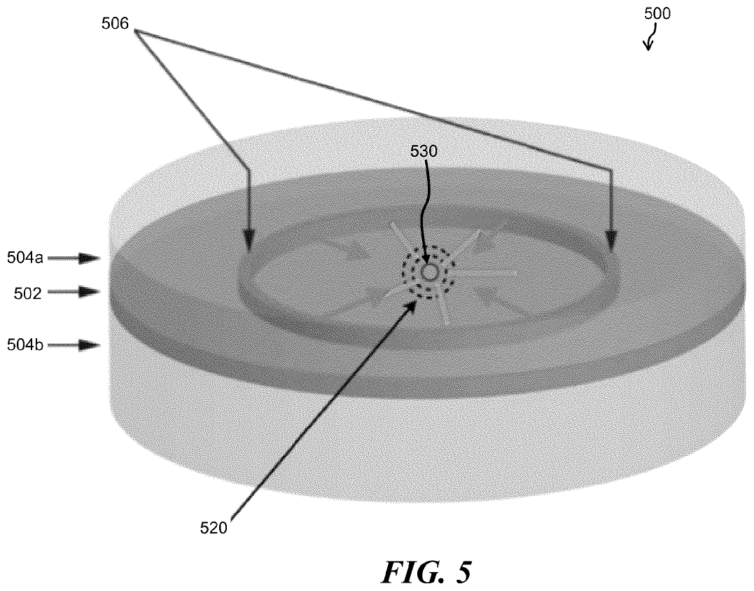

Turning to FIG. 5, many different target assembly configurations may be used with the multi-shock systems and techniques disclosed herein. For the shock-induced fusion process, fusion samples made of a mixture of deuterium and tritium may produce high net energy gain during the fusion process. Fusion samples of this type can take various forms including but not limited to: (1) liquid thin film in the approximately 1-50 micrometers thickness range of deuterium-tritium; and (2) solid thin film in the approximately 1-50 micrometers thickness range deuterium-tritium. (3) liquid thin film in the approximately 1-50 micrometers thickness range of heavy water with a deuterium-tritium bubble trapped at the center of the laser rings; (4) frozen thin film in the approximately 1-50 micrometers thickness range of heavy water with a deuterium-tritium bubble trapped at the center of the laser rings. Here, “thin film” refers to a film having a thickness in the range of several tens of micrometers or less (e.g., less than 90, 80, 70, 60, 50, 40, 30, or 20 micrometers.) In any of these example, deuterium-tritium can be replaced with deuterium-only constituents.

In some embodiments, the shock propagation layer may contain materials that absorb the excitation laser light in order to deposit the laser pulse energy into the layer where it can launch a shock wave. The light-absorbing material could be the liquid, polymer or other material of which the layer is primarily composed, or it could be added to the primary layer constituent. Added constituents could be, for example, carbon nanoparticles or other small nanoparticles, or dye compounds or other absorbing chemical species, which upon absorption of intense laser light may be heated such that the nearby material are vaporized, generating pressure to launch the shock wave. The absorptive materials can include semiconductor particles, dyes, or other constituents that undergo absorption spectral shifts under pressure such that their absorption of the laser light is increased when they are under shock pressure, thereby ensuring maximum light absorption at the shock location where the pressure is maximum.

FIG. 5 shows an illustrative target assembly 500 that can be used, for example, within the system of FIG. 1, FIG. 9, or FIG. 10, according to some embodiments. The target assembly 500 includes a shock propagation layer 502 disposed between an upper substrate 504a and a lower substrate 504b. The shock propagation layer 502 and/or substrate layers 504a, 504b can be provided from any of the materials described above, or other materials, in conjunction with FIG. 4A. An excitation laser ring 506 (or many concentric rings as also shown in FIG. 11, or many parallel lines or multiple arrays of parallel lines) can be generated to propagate shock waves towards a focal region 520 using, for example, the planar multi-shock technique described above in the context of FIG. 2A. A fusion sample 530 can be placed within the focal region 520 for fusion ignition. In some embodiments, fusion sample 530 may be a deuterium-tritium bubble or droplet trapped, for example, in a resonant acoustic field. In general, fusion sample 530 can comprise any material that can induce nuclear fusion in the gas, liquid or solid state.

Considering the extreme temperature and pressure conditions needed for thermonuclear fusion, the sample 530 may be irreversibly damaged after each laser shot. The energy released during the fusion process can be collected via the emission of high-energy neutrons and other high-energy particles or photons escaping from the fusion core at the center of the laser rings. The diameter of the excitation laser ring 506 (or any one of multiple concentric rings) that launch the shocks may be on the order of hundreds or tens of micrometers in diameter, and could extend to sizes in the millimeter range. The damaged sample area may be of the same order in size. To produce large amounts of fusion energy, in some embodiments rastering of the sample can be performed in between laser shots. For example, after each laser shot, the sample 530 can be moved to a non-damaged area within the shock propagation layer 502 and thermonuclear fusion can be initiated again to produce high-energy neutrons from the non-damaged area. In other embodiments, many smaller samples (e.g., samples having millimeter or centimeter in-plane dimensions) can be fabricated, and a new sample can be used for each laser shot.

One advantage of the structures and techniques disclosed herein is that the laser energy is split into many laser beams. Each of these laser beams may be absorbed strongly in the region of the shock propagation layer that it irradiates, thereby contributing effectively to the velocity-matched shock wave to produce extremely high peak pressure and temperature. This approach circumvents the low efficiency of shock generation that may occur due to reduced absorption of the laser energy. This low efficiency is one of the main limitations in current laser-based shock fusion ignition efforts, where the formation of plasma during the first part of the irradiating laser pulse results in high reflectivity for the rest of the irradiating laser pulse, drastically reducing the efficiency of shock excitation. In current laser-based inertial confinement fusion experiments, most of the energy is reflected by the plasma and only a small portion of the laser energy couples to the excitation of shock waves. The present disclosure allows most of the excitation laser pulse energy to be absorbed and opens the way to orders of magnitude higher efficiency for shock excitation.

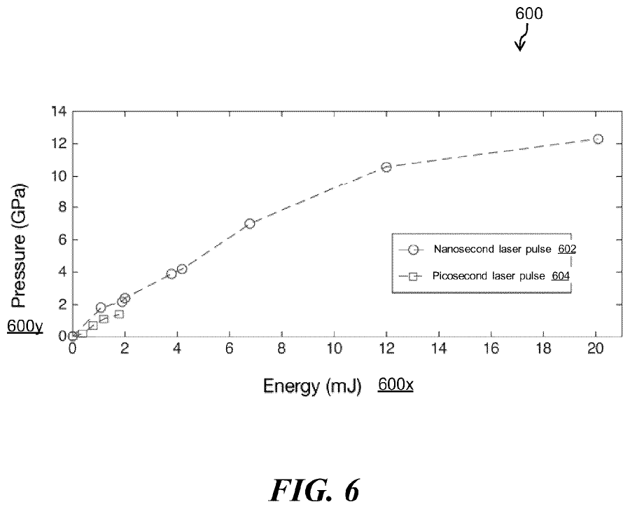

Turning to FIG. 6, an illustrative plot 600 illustrates measured shock pressures 600y at a focal region versus excitation laser pulse energy 600x. The measured shock pressures 600y correspond to shock pressures measured at 15 nanoseconds time delay after shock excitation in a water shock propagation layer sandwiched between two glass substrates. The excitation laser pulse energy 600x corresponds to excitation laser pulse energy from a nanosecond or picosecond duration laser pulse focused to a 100-micron diameter ring at the focal region. As shown, plateauing of the shock pressure can occur when high laser pulse energies are used to excite a sample positioned within the focal region. The efficiency of the laser shock excitation from a single laser pulse may not scale linearly with laser pulse energy because absorption of the laser light may saturate at increasing energies, resulting in a plateau in the amount of laser pulse energy that contributes to shock generation. The technique disclosed herein circumvents this problem. The data labeled 602 were obtained using a nanosecond duration excitation laser pulse, and the data labeled 604 were obtained using a picosecond duration excitation laser pulse.

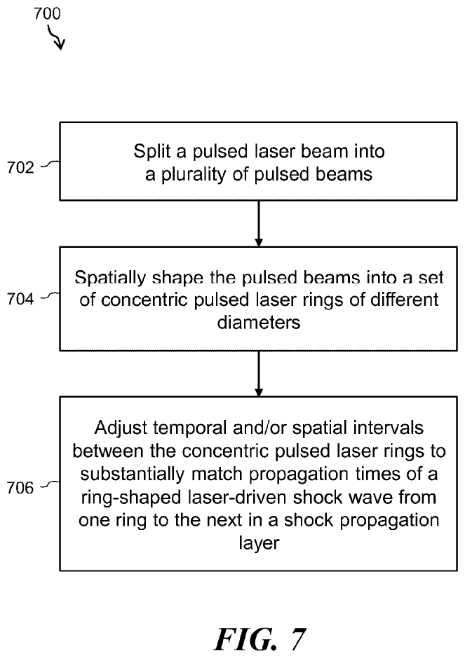

FIG. 7 is a flow diagram showing a method 700 for synchronous excitation of multiple shock waves in a target assembly, according to some embodiments of the present disclosure. At block 702, a pulsed laser beam can be split into a plurality of pulsed laser beams. The pulsed laser beam can be generated by one or more laser sources such as a laser source described above in the context of FIG. 1. At block 704, the plurality of pulsed laser beams can be spatially shaped into a plurality of concentric pulsed laser rings of different diameters. Techniques for such spatial shaping are described above in the context of FIGS. 1 and 2A. At block 706, temporal and/or spatial intervals (e.g., ring diameters) between the concentric pulsed laser rings can be adjusted to substantially match propagation times of a ring-shaped laser-driven shock wave from one ring to the next in a shock propagation layer of the target assembly. Techniques for controlling such temporal or spatial intervals are described above in the context of FIGS. 1 and 2A. The ring-shaped laser-driven shock waves can propagate substantially within the plane of the shock propagation layer and converge toward a focal region where, for example, a fusion sample is positioned. In some embodiments, the method 700 can further include, coincident with the convergence of the in-plane ring-shaped shock waves at the focal region, directing through-plane shock waves at the focal region or directing through-plane laser light that is directly absorbed by the fusion sample.

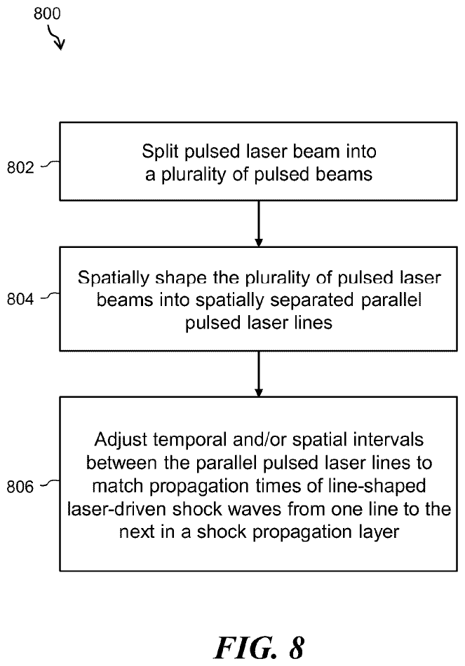

FIG. 8 is a flow diagram showing another method 800 for synchronous excitation of multiple shock waves in a target assembly, according to some embodiments of the present disclosure. At block 802, a pulsed laser beam can be split into a plurality of pulsed laser beams. The pulsed laser beam can be generated by one or more laser sources, such as a laser source described above in the context of FIG. 1. At block 804, the plurality of pulsed laser beams can be spatially shaped into spatially separated parallel pulsed laser lines. Techniques for such spatial shaping are described above in the context of FIGS. 1 and 3A. At block 806, temporal and/or spatial intervals between the parallel pulsed laser lines can be adjusted to match the propagation times of a line-shaped laser-driven shock wave from one line to the next in a shock propagation layer of the target assembly. Techniques for controlling such time intervals are described above in the context of FIGS. 1 and 3A. In some embodiments, the line-shaped shock waves can propagate substantially within the plane of the shock propagation layer and converge toward a focal region after passing through or reflecting from an acoustically focusing element, as discussed above in the context of FIG. 3A. In some embodiments, the method 800 can further include, coincident with the convergence of the in-plane shock wave at the focal region, directing through-plane shock waves at the focal region. In some embodiments, the method 800 can include multiple arrays of pulsed laser lines to generate multiple in-plane shock waves that propagate in different directions in the sample plane such that the shock waves intersect at a region of the shock propagation layer at which the shock pressure is increased.

One application of present disclosure is thermonuclear fusion for the production of energy. Other applications include the production of high pressures and high temperatures for the characterization or synthesis of materials under extreme conditions which can be attractive for many research and development entities. In some such applications a laser source providing as little as 10 millijoules energy might be sufficient. In some embodiments this may benefit from multiple shocks rather than one large shock, and this can be achieved by adjusting the spatial and/or temporal separation of rings or lines appropriately as described earlier. Disclosed embodiments can be practiced using relatively low-cost, readily available lasers (e.g., Nd:YAG lasers) and do not require the use of a gas gun or dangerous explosives that are sometimes used to reach high pressures. In some embodiments, the structures and techniques disclosed herein can be implemented within small-scale devices that can be operated close to a customer's site of use (district, building, house, ship etc.). As such, the present disclosure may circumvent the problems of losses or impracticality in electric power transportation from the power plant or power generation site to the customers.

Another application of the present disclosure is the production of tritium atoms using apparatus that may, for example, be small enough to fit on a laboratory benchtop. Thus, in FIG. 9 is shown a schematic representation of an apparatus 900 for inertial confinement fusion and tritium production. A picosecond (ps) laser source 910 is configured to output a Gaussian laser pulse 915, which is subsequently split by beamsplitters 920a, 920b, 920c (collectively “beamsplitters 920”) and directed by mirrors into respective axicon telescopes. 930a, 930b, 930c, 930d (collectively “axicon telescopes 930”).

Each axicon telescope includes at least two lenses, at least one of which is an axicon. As is known in the art, an axicon has a conical surface and converts an input laser beam into a ring of coherent light. Thus, by way of illustration only, axicon telescope 930d includes two axicons 932 and 936 and two focusing lenses 934 and 938. The split pulse enters the axicon telescope 930d, is shaped by the axicon 932 to become a laser ring, which is refracted by the focusing lens 934, reshaped by the axicon 936, and finally refocused by focusing lens 938 before exiting the axicon telescope 930d. The position of axicon 936 determines the diameter of the laser ring output by the telescope 930d, as is true for the other axicon telescopes 930a-c. The laser rings from the axicon telescopes 930 are recombined using beamsplitters 940a, 940b, 940c, 940d into a series of laser rings spatially and temporally separated according to desired sample surface impact parameters.

In particular, the positions of the axicons are adjustable along the optical axis of each telescope, allowing for control over the diameter of each laser ring. The time intervals between pulses forming different rings, as well as the spatial separations between the rings, can be finely adjusted to match the propagation speed in the sample of the laser-driven shock waves from one ring to the next by changing the path distance. Thus, the bottom axicon telescope 930a in FIG. 9 produces the outermost, largest ring first, as its light travels the shortest distance, while the top axicon telescope 930d produces the innermost, smallest ring last.

While only four such axicon telescopes 930 are shown in FIG. 9, it is appreciated that any number of at least two axicon telescopes may be used to produce an equal number of shock rings that constructively interfere. This configuration ensures that the timing of the pulses and the diameters of the rings are controlled to satisfy the phase matching conditions necessary for coherent excitation and the build-up of a primary shock wave traveling towards a shock focal region in the sample.

In addition to the primary shock wave, other weaker shock waves may be launched by the pulsed laser light, potentially propagating in different directions or regions of the target assembly. While the present embodiment describes the use of four concentric rings, the system is adaptable to accommodate other numbers of rings as required by specific applications.

Further technical details of the apparatus shown in FIG. 9 include the application of a second laser. For example, a femtosecond (fs) laser 950 can be employed to deliver a Gaussian pulse 955 into the sample, generating a cavitation bubble at the center of the laser rings. The subsequent collapse of this cavitation bubble by the focusing shock waves significantly enhances the pressure and temperature within the sample, compared to the effects produced by the focusing rings alone. Although a fs laser 950 is sketched here, a picosecond laser, a nanosecond laser, or a neutron tube can be applied for the cavitation generation.

The target assembly of FIG. 5 can be used with the embodiment of FIG. 9. Thus, the shock propagation layer 502 may be nuclear material including deuterium or lithium-7, the upper substrate 504a may be provided as a transparent cover, and the lower substrate 504b may be a breeding blanket that further comprises neutron-multiplying materials, including but not limited to beryllium or lead, to enhance the neutron economy within the system. These materials are selected for their ability to multiply neutrons through (n,2n) reactions, thereby optimizing tritium production. Thus, the breeding blanket may comprise, e.g., a lithium-lead alloy or similar material having both fusion elements and neutron multiplying elements.

The system includes provisions for the extraction and recovery of tritium generated within the blanket. The technique incorporates an adapted version of hydrogen extraction techniques to minimize tritium retention within the breeding materials and ensure safe handling of the radioactive tritium. For example, one of the tritium extraction techniques can be an electrochemical process, in which the blanket is immersed in an electrolytic solution, and an electrical current is applied using a power supply. This forces hydrogen isotopes (including tritium) to leave the blanket. It is appreciated that other techniques for extraction and recovery of tritium are known in the art and may be used, and embodiments are not limited to the technique just described.

In FIG. 10 is shown a schematic representation of an apparatus 1000 for inertial confinement fusion and tritium production according to a second embodiment of the concepts, techniques, and structures disclosed herein. Just as in FIG. 9, this apparatus 1000 includes a picosecond laser 1010 and four axicon telescopes 1020a, 1020b, 1020c, 1020d. In contrast to FIG. 9, the apparatus 1000 forms laser rings to excite the sample from both the front and back sides. This two-sided excitation reduces laser energy loss at the polarized beamsplitters (e.g., beamsplitter 1030), thereby enhancing the efficiency of the system. In the illustration, two axicon telescopes on each side of the sample are depicted (i.e., axicon telescopes 1020a and 1020b on the left and axicon telescopes 1020c and 1020d on the right); however, the total number of axicon telescopes and their distribution can be adjusted as needed for specific applications. A second laser (e.g., a fs-laser) or neutron gun can also be applied to induce a cavitation bubble, following the same principle as described in connection with FIG. 9.

In FIG. 11 is shown a perspective view of a sample assembly that can be used with the embodiment of FIG. 10. To permit laser rings to impinge the nuclear material from both sides, the lithium-lead alloy breeding material of the lower substrate 504b from FIG. 5 is replaced by a second transparent cover, and the breeding material itself is migrated to a cylinder 1100 which surrounds and contains the target. It is appreciated that the sample assemblies shown in FIG. 5 and FIG. 11 are merely illustrative of the general principle that laser-generated shock waves may be induced in a thin layer of nuclear material to produce tritium atoms by fusion, and that a person having ordinary skill in the art may use this principle in accordance with sample assemblies having other shapes.

The apparatus of either FIG. 9 or FIG. 10 generates high pressure, inducing a nuclear reaction in the tritium breeding blanket:

$${Li}^{7} + n \to T + {He}^{4} + n ’ \qquad ( 1 )$$

wherein lithium-7 isotopes are employed to produce tritium via high-energy neutron interactions. Alternately, FIG. 12 shows another pathway for direct tritium production through focusing shocks using the reaction:

$$D + D \to T + p \qquad ( 2 )$$

wherein two deuterium atoms D fuse to generate a tritium atom T and a proton p.

Notably, a main objective of the apparatus and processes disclosed herein is to produce tritium atoms on a small scale, such as a laboratory benchtop. Therefore, energy loss due to, e.g., multiple rings passing through a polarized beamsplitter is not as crucial as it would be in a commercial energy production application. Advantageously, it is possible to use a more powerful laser to produce higher pressures and higher rates of tritium production, even knowing that there will be increased power loss. Alternately, it is possible to use (or add) another picosecond laser having a second wavelength, and use a dichroic beamsplitter instead of (or in addition to) a polarized beamsplitter.

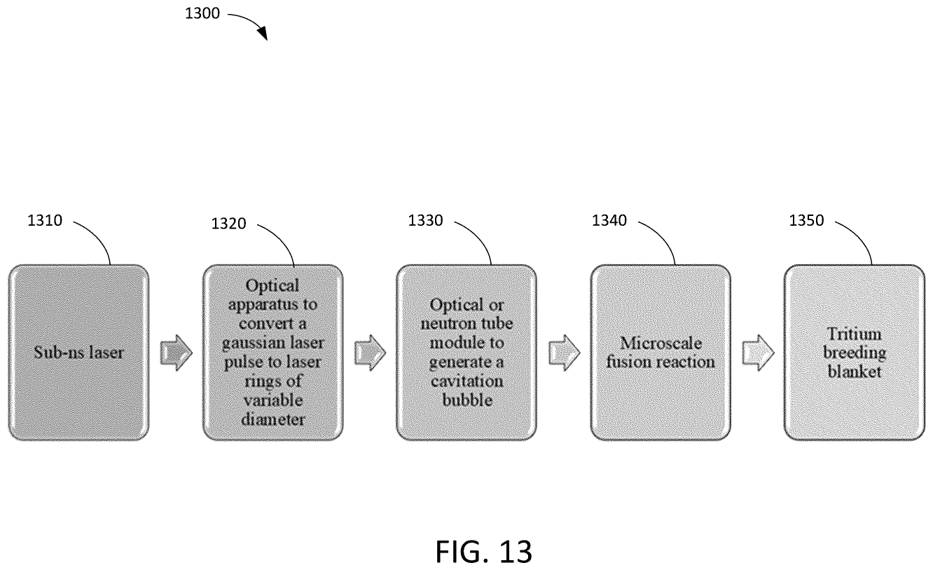

In FIG. 13 is shown a flow diagram 1300 of a process for tritium production, according to various embodiments. A sub-nanosecond or picosecond laser 1310 provides a driving energy source. The laser pulse can be subsequently converted by optical apparatus 1320 (e.g., the apparatus 900 shown in FIG. 9 or the apparatus 1000 shown in FIG. 10) into laser rings of variable diameters. These rings will impinge on a sample at different times so as to constructively interfere in a shock wave that converges on a shock focus. Meanwhile, an optical or neutron tube module 1330 generates a cavitation bubble at the shock focus, thereby reducing the shock energy required to initiate fusion. When the shock wave reaches the cavitation bubble at the shock focus, a microscale fusion reaction 1340 occurs. Neutrons produced from this reaction enter the top surface of a tritium breeding blanket 1350 (e.g., a lithium-lead substrate as described in connection with FIG. 9, or a surrounding cylinder as described in connection with FIG. 10), penetrating about 50 microns and producing additional tritium atoms therein.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent or similar constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter. It is also understood that the present disclosure does not describe in full detail all of the effects of the laser-driven shock which, in addition to achieving high peak shock pressure, may result in high temperature, compressional collapse of material in the shock propagation layer, and other effects. The spatial and temporal separations between laser rings or lines, and other parameters of the laser excitation process, may be adjusted to optimize any of the induced effects as well as the peak shock pressure. Of note, the target assembly can be sealed to confine any of these induced effects for optimization of the fusion process.

As used herein, “including” means including without limitation. As used herein, the terms “a” and “an”, when modifying a noun, do not imply that only one of the noun exists. As used herein, unless the context clearly indicates otherwise, “or” means and/or. For example, A or B is true if A is true, or B is true, or both A and B are true. As used herein, “for example”, “for instance”, “e.g.”, and “such as” refer to non-limiting examples that are not exclusive examples. The word “consists” (and variants thereof) are to be give the same meaning as the word “comprises” or “includes” (or variants thereof).

The above description (including any attached drawings and figures) illustrates implementations of the concepts described herein. However, the concepts described herein may be implemented in other ways. The methods and apparatus which are described above are merely illustrative applications of the principles of the described concepts. Numerous modifications may be made by those skilled in the art without departing from the scope of the invention. Also, the described concepts include without limitation each combination, sub-combination, and permutation of one or more of the abovementioned implementations, embodiments and features.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the preceding description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description herein, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the specification to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

What is claimed is:

1. Apparatus comprising:
a picosecond laser for producing a Gaussian laser pulse;
a first plurality of beamsplitters for splitting the Gaussian laser pulse into a plurality of laser pulses;
a plurality of axicon telescopes, each axicon telescope coupled to a respective laser pulse in the plurality of laser pulses and having an axicon, wherein each axicon telescope receives its respective laser pulse at a time determined by a distance traveled by the respective laser pulse, and each axicon telescope forms its respective laser pulse into a laser ring having a diameter according to a position of its axicon; and
a second plurality of beamsplitters for combining the laser rings into an output series of pulses;
wherein the beamsplitters and axicon telescopes are arranged so that the output series of pulses produces shock waves in a sample assembly that constructively interfere at a focal region so as to initiate a fusion reaction that produces tritium.

2. The apparatus of claim 1, further comprising, for creating a cavitation bubble in the sample assembly at a focal point of the shock waves, a femtosecond laser, or a picosecond laser, or a nanosecond laser, or a neutron generator tube.

3. The apparatus of claim 1, wherein the beamsplitters and axicon telescopes are arranged to excite the sample assembly from two opposite sides thereof.

4. The apparatus of claim 1, wherein the sample assembly comprises a lithium blanket for neutron bombardment.

5. The apparatus of claim 1, wherein the sample assembly comprises at least one of:
a liquid or solid film of deuterated acetone C₃D₆O;
a liquid film of deuterium-tritium;
a liquid film of deuterium constituents;
a solid film deuterium-tritium;
a solid film of deuterium constituents;
a liquid film of heavy water (D₂O) with a trapped deuterium-tritium bubble;
a liquid film of heavy water with a trapped deuterium bubble;
a frozen film of heavy water with a trapped deuterium-tritium bubble; or
a frozen film of heavy water with a trapped deuterium bubble.

6. The apparatus of claim 1, wherein the sample assembly is tapered with gradually shrinking sample layer thickness towards the center.

7. The apparatus of claim 1, wherein the beamsplitters and axicon telescopes are further configured to excite the sample assembly by through-plane shock waves.

8. A method of producing tritium from nuclear material in a sample assembly, the method comprising:
producing a Gaussian laser pulse using a first sub-nanosecond laser;
converting the Gaussian laser pulse into laser rings of variable diameters, each such laser ring impinging on the nuclear material at a different time to produce a corresponding shock wave in the nuclear material; and
generating a cavitation bubble at a focus of the shock waves in the nuclear material, using a second sub-nanosecond laser or a neutron tube;
wherein the shock waves constructively interfere at the focus so as to initiate a fusion reaction that produces tritium.

9. The method of claim 8, wherein the fusion reaction also produces neutrons, the method further comprising directing said neutrons into a breeding blanket.

10. The method of claim 9, wherein the breeding blanket comprises lithium.

11. The method of claim 8, wherein the nuclear material comprises at least one of:
a liquid or solid film of deuterated acetone C₃D₆O;
a liquid film of deuterium-tritium;
a liquid film of deuterium constituents;
a solid film deuterium-tritium;
a solid film of deuterium constituents;
a liquid film of heavy water (D₂O) with a trapped deuterium-tritium bubble;
a liquid film of heavy water with a trapped deuterium bubble;
a frozen film of heavy water with a trapped deuterium-tritium bubble; or
a frozen film of heavy water with a trapped deuterium bubble.

12. The method of claim 8, wherein converting the Gaussian laser pulse into laser rings of variable diameters comprises:
splitting the Gaussian laser pulse into a plurality of laser pulses using one or more first beamsplitters;
directing each of the plurality of laser pulses into a respective axicon telescope where it is formed into a respective laser ring having a respective diameter; and
combining the respective laser rings using one or more second beamsplitters.
